(19) United States
(12) Patent Application Publication
(10) Pub. No.: US 2009/0077186 A1
(43) Pub. Date: Mar. 19, 2009

(54) Interface, system and method of providing instant messaging service

(75) Inventors: Chaucer Chiu, Taipei (TW); Nasara Yue, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 11/898,826

(22) Filed: Sep. 17, 2007

(51) Int. Cl. G06F 15/16

(52) U.S. Cl. 709/206

(57) ABSTRACT

An interface, a system and a method of providing an instant message service are provided, so as to solve a problem that the interface of providing the instant message service is excessively dull. A first image is used to represent a user, and a second image is used to represent a contactor. When the contactor sends an instant message to the user, the instant message is displayed around the second image representing the contactor sending the message, thereby achieving a function of a livelier interface.

### BACKGROUND OF THE INVENTION

1. Field of Invention

The present invention relates to an interface, a system and a method of providing an instant message service, and more particularly to an interface, a system and a method of providing a instant messaging service, which are capable of using an image to represent a contactor and displaying instant messages around the image.

2. Related Art

Internet is indispensable for most of the people, and an instant messaging service on the Internet is further an indispensable service for the users of the Internet. The users can use the service to perform instant text or audio-video communication service with another person or several other persons.

Recently, several kinds of instant messaging service are usually used, but they all use a window display mode. That is to say, recently, the interface provided for using the instant message has a main window for displaying a contactor list of the user. When the user intends to send an instant message to one of the contactors, the contactor is selected in the main window, and thus the interface newly displays a conversation window provided for the user to input the instant message and to display the instant messages transmitted by the user and the contactor. Alternatively, when the contactor initiatively sends the instant message to the user, the interface also initiatively displays the conversation window, displays the instant message sent by the contactor on the conversation window, and simultaneously provides a block for the user to input the instant message.

However, the above method of displaying the instant message is limited by the characteristic of the window, and the interface representation is excessively dull, so some interfaces of providing instant messaging service are particularly changed, for example, some personalized pictures are added on the window providing the conversation, or the user is enabled to send the instant message in a manner of animations or pictures, and in some interfaces, the four boundaries of the conversation window are omitted as much as possible. However, the changes are only on the window display, the method is substantially still limited by the characteristic of the window, and it is impossible to present the interface of providing instant messaging service in a livelier manner.

### SUMMARY OF THE INVENTION

The present invention is directed to provide an interface, a method and a system of providing a instant message service, which are capable of solving the problem in the prior art that the recent interface of providing the instant message service is excessively dull.

The system of providing the instant message service provided in the present invention includes a contactor display module, an image display module, a message input module, a message transmission module, and a message display module. The system displays contactors and a user in a manner of images, and displays instant messages of the conversation in the first image or the second image corresponding to the user or the contactor sending the instant message, so as to solve the problem that the interface of providing the instant message service is excessively dull.

The method of providing the instant message service provided in the present invention includes displaying the first image representing the state of the user and selecting at least one contactor from a contactor list; respectively displaying each second image representing the state of the selected contactor; after the user inputs a first instant message, sending the first instant message to each selected contactor; and when a second instant message sent by each contactor is received, displaying the second instant message around the second image corresponding to the contactor. The first image is used to represent the user, and the second image is used to represent the contactor. When the user or the contactor sends the first or the second instant message, the received or sent second or first instant message is displayed around the second image or the first image corresponding to the contactor or the user sending the second or the first instant message, so as to solve the problem that the interface of providing the instant message service is excessively dull.

The interface of providing the instant message service provided in the present invention includes a main window, a first image, a message input block, a second image, and a message display block. The instant message sent by the user is displayed around the first image, and the instant message sent by the corresponding contactor is displayed around the second image, so as to solve the problem that the interface of providing the instant message service is excessively dull.

Therefore, the present invention can successfully display the instant messages sent and received by the user, and solve the problem that the interface of providing the instant messaging service is excessively dull.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is an architecture view of the system of providing the instant messaging service according to the present invention.

FIG. 2 is a flow chart of the method of providing the instant messaging service according to the present invention.

FIG. 3 is a schematic view of the interface of providing the instant messaging service according to the present invention.

FIG. 4A is a schematic view of the interface of providing the instant messaging service according to the present invention.

FIG. 4B is a schematic view of the interface of providing the instant messaging service according to the present invention.

FIG. 4C is a schematic view of the interface of providing the instant messaging service according to the present invention.

FIG. 5A is a schematic view of the interface of providing the instant messaging service according to the present invention.

FIG. 5B is a schematic view of the interface of providing the instant messaging service according to the present invention.

FIG. 6 is a schematic view of the interface of providing the instant messaging service according to the present invention.

FIG. 7 is a schematic view of the interface of providing the instant messaging service according to the present invention.

### DETAILED DESCRIPTION OF THE INVENTION

Only after a user uses his/her account number and password to log in an instant messaging service, can instant messages be sent to the contactors logging in the same instant message service, where the contactors of the user are set by the user. When the user inputs the instant message and selects to send the message on an electronic device, the instant message input by the user is sent to the network, and is finally displayed on the electronic device used by the contactor.

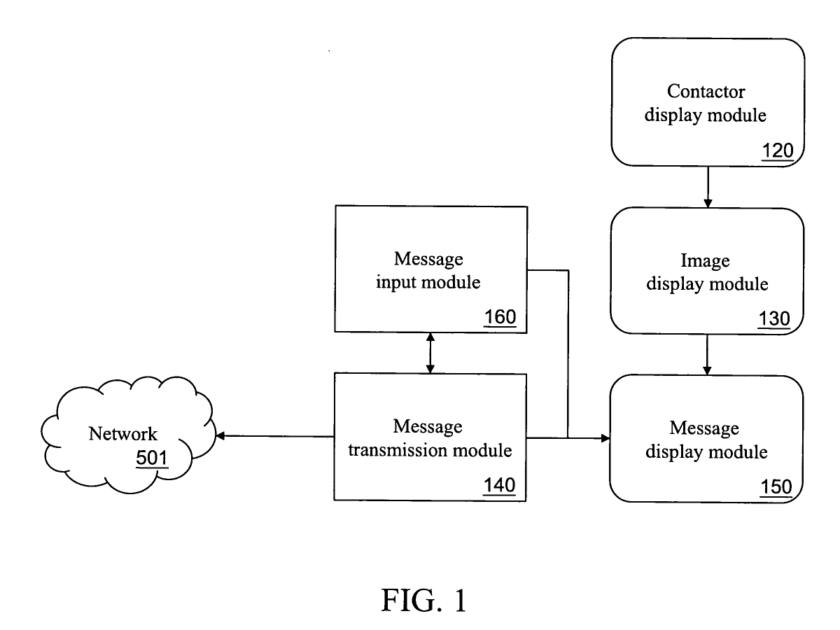

The operation of the system of the present invention is illustrated as FIG. 1 below, and FIG. 1 is an architecture view of the system of providing the instant messaging service according to the present invention. As shown in the drawing, the system of the present invention includes a contactor display module 120, an image display module 130, a message transmission module 140, a message display module 150, and a message input module 160.

The contactor display module 120 is responsible for displaying each contactor set by the user in a main window, so as to form a contactor list. In this manner, the user can select a contactor from the contactor list to send a first instant message (i.e. the contactor is the person with whom the user intends to use the instant message service to talk). In order to enable the user view the contactors more conveniently, the sequence of the contactors in the main window can be randomly arranged, or can be arranged according to some parameters such as frequency, times, and time duration of the talk between the user and each contactor.

The image display module 130 is responsible for displaying the first image according to a current state of the user (for example, busy, leaving, and dining etc.), and for displaying a second image according to the state of the selected contactor at the time when the user selects at least one contactor in the contactor display module 120. The second image can be pre-stored in the image display module 130 and be displayed after being read by the image display module 130, or can be displayed by the image display module 130 after being sent to the image display module 130 by the electronic device used by the selected contactor through the network. In addition, in the present invention, each selected contactor at least corresponds to a second image.

In addition, the “image” in the present invention can also be referred to as “little helper”, “genius”, or “virtual agent” etc., actually it is an object using pictures or simple animations to interact with the user, thereby providing a certain degree of suggestion when the user performs the interface operation. At the same time, it is possible to make the color of the picture representing the object change or to display different animations according to the different operation status of the user. For example, when the state of the user is changed to be angry, a background of the picture is changed to be red; when the program is started, an animation of a bow representing a welcome is displayed; and when the operation is false, an animation of head shaking is displayed. According to the image characteristic, the first image and the second image can use the animations, the pictures and other manners to represent the state of the corresponding user or contactor. For example, when the user or the contactor is angry, crying, pleased, or wrathful, the pictures can be replaced to represent the different facial expressions, and when the user or the contactor is sleeping, making a phone call, or dining, the first image and the second image can also use the corresponding animations or pictures for representation.

The message transmission module 140 is responsible for transmitting the first instant message input by the user to the contactor selected by the user through the instant messaging service on a network 501, and for receiving the second instant message sent to the user by each contactor through the instant message service.

The message display module 150 is responsible for displaying the second instant message received by the message transmission module 140 around the second image corresponding to the contactor. The manner of displaying the second instant message is, for example, represented in a manner of dialogue text, but the manner of displaying the second instant message of the present invention is not limited to the dialogue text, all manners capable of making the user know which contactor sends the second instant message can be used by the present invention. In addition, the first instant message input by the user through the message input module 160 can be displayed around the first image corresponding to the user.

The message input module 160 is provided for the user to input the first instant message, and after the user finishes the input, the message input module 160 sends the first instant message to the contactor to whom the user intends to send the first instant message through the message transmission module 140.

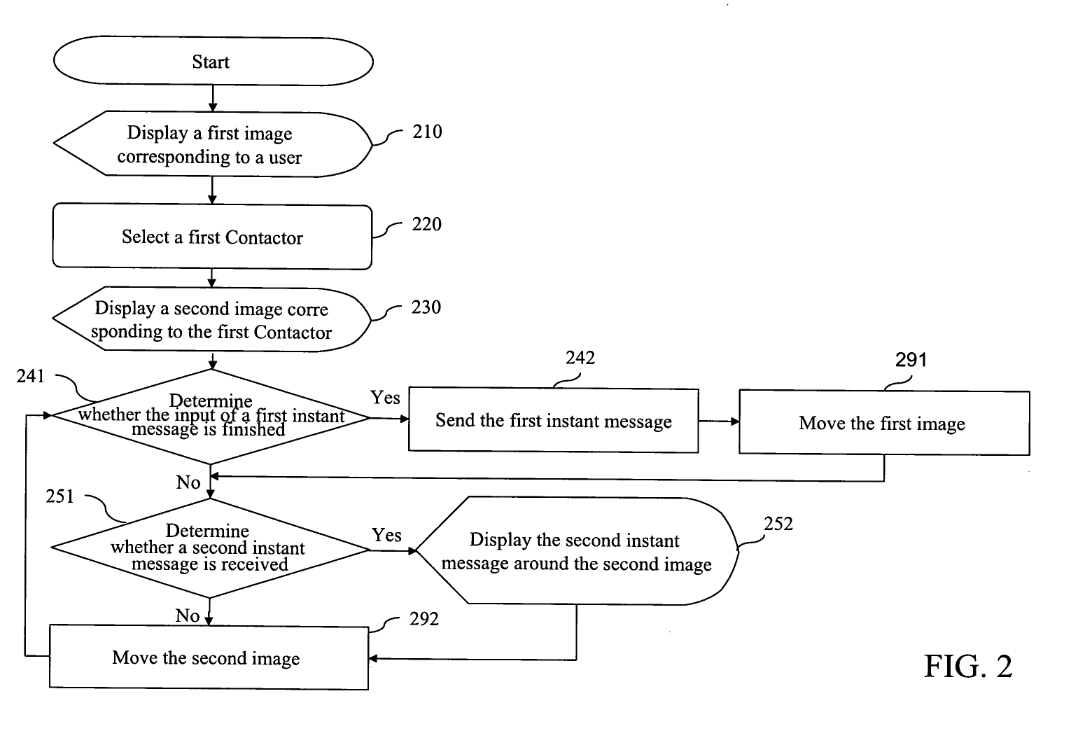

Next, an embodiment is used to illustrate the operation system and the method of the present invention. Referring to FIGS. 1 and 2, FIG. 1 is an architecture view of the system of providing the instant messaging service according to the present invention, and FIG. 2 is a flow chart of the method of providing the instant messaging service according to the present invention.

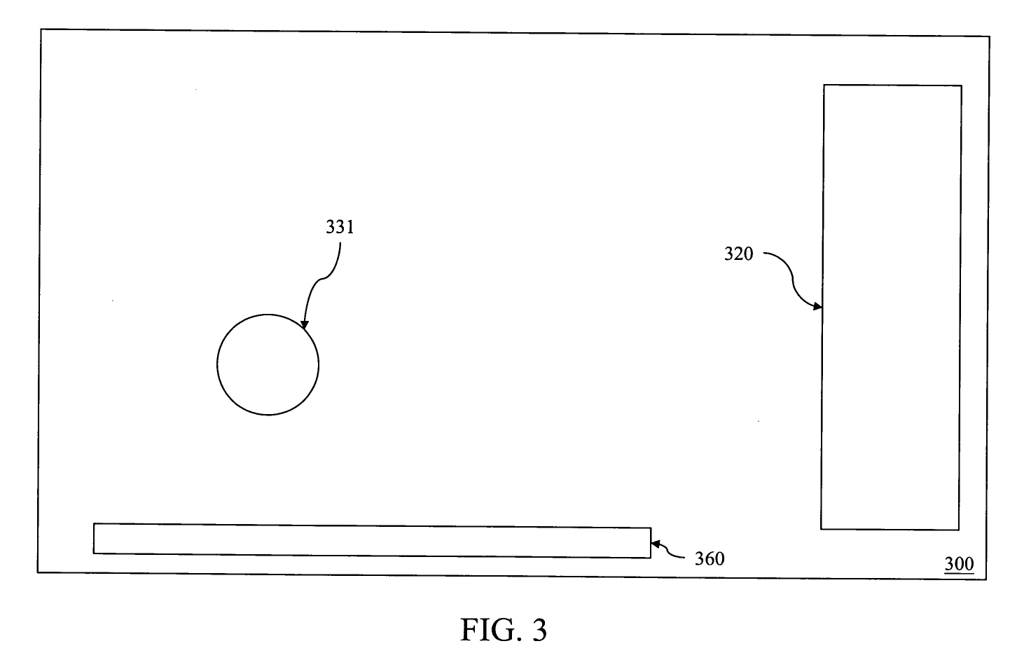

As shown in FIG. 3, after the user logs in the instant message service, the contactor display module 120 displays the contactors' information of the user on a main window 320 in a list form, but the manner of displaying the contactors of the present invention is not limited to the list, and any method capable of making the user understand can be used by the present invention. Next, the image display module 130 displays a first image 331 corresponding to the user in an interface 300 provided by the present invention (step 210).

When the user intends to use the instant message to have a conversation with a first contactor, the user selects the first contactor from the contactor list of the main window 320 (step 220), in this manner, the image display module 130 determines the position of the second image 332 corresponding to the first contactor occurred in the interface 300 randomly or after a specific calculation, and displays the second image 332 corresponding to the first contactor in the interface 300 (step 230).

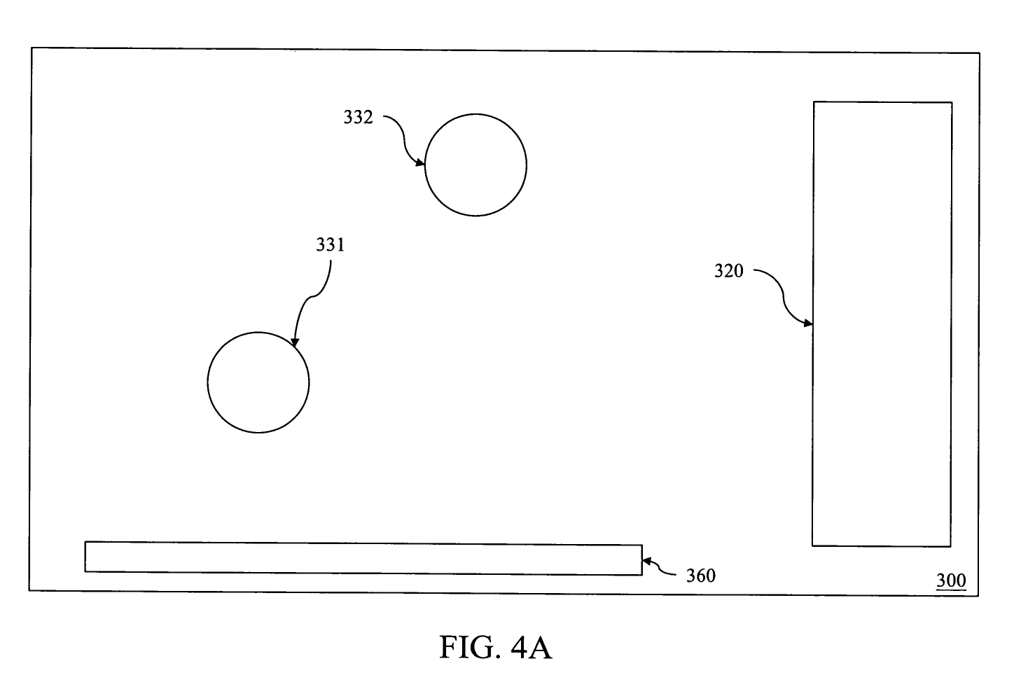

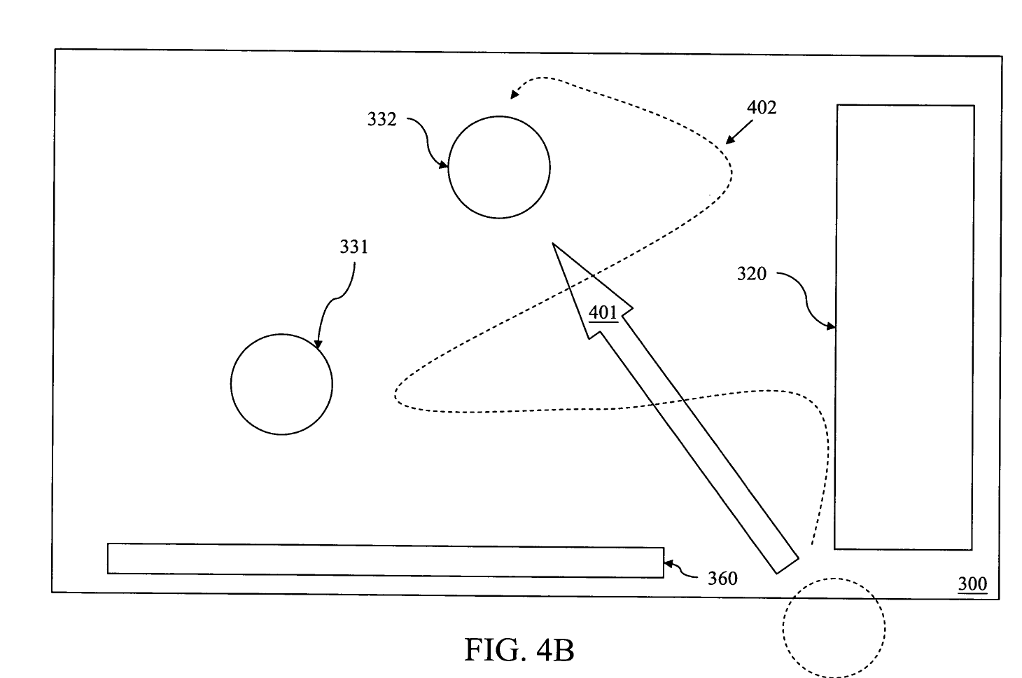

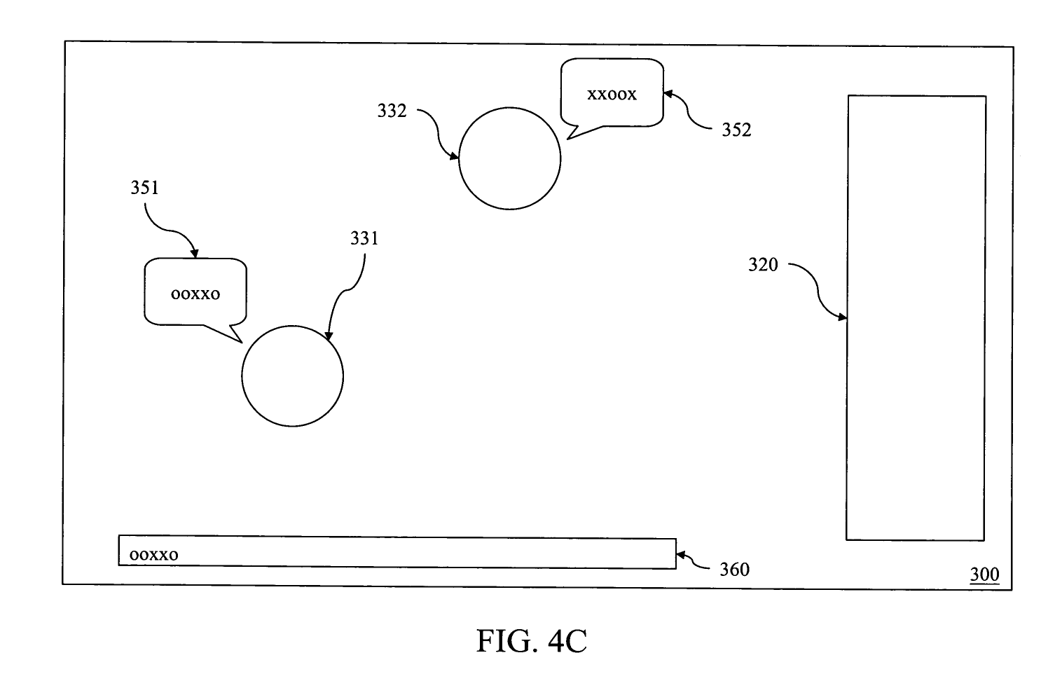

The manner of displaying the second image 332 is, for example, directly displaying the second image 332 on an objective position as shown in FIG. 4A, or displaying the second image 332 by adding relatively complicated heading animations including fading in and suddenly occurring etc. on the objective position. Even as shown in FIG. 4B, an occurring position is randomly selected out of four boundaries of the interface 300, then the second image 332 is moved from the selected occurring position to the objective position, and the process of moving the second image 332 can be a straight moving as shown by an arrow 401 in FIG. 4B, and can also be an irregular random moving as shown by a dotted line 402 in FIG. 4B. However, the method of displaying the second image 332 (step 230) is not limited in the present invention, and the methods capable of displaying the second image 332 on the objective position can be used by the present invention.

If the image display module 130 does not randomly determine the occurring position of the second image 332 corresponding to the first contactor, a certain calculation manner, for example, according to the parameters such as the frequency, the time duration, and the times of the conversation between the first contactor and the user, can be made to determine the distance between the first image 331 and the second image 332. For example, a corresponding table is preset, the corresponding table has a times value and a corresponding distance value, and the higher the times value is, the smaller the distance value is. That is, as the values of the parameters such as the frequency, the time duration, and the times of the conversation become higher, the occurring position of the second image 332 becomes nearer to the first image 331, so as to represent the familiarity degree of the user and the first contactor, but the manner of calculating the distance provided by the present invention is not limited here.

After the second image 332 corresponding to the first contactor is displayed in the interface 300 by the image display module 130, the message input module 160 of the present invention judges whether the user finishes inputting the first instant message in the message input block 360 (step 241). If the user determines to send the input text, it indicates that the input of the first instant message is finished, at this time the message input module 160 sends the first instant message to the message transmission module 140, and thus the message transmission module 140 sends the first instant message to the first contactor through the instant messaging service (step 242). In addition, the user can also set whether it is necessary for the message display module 150 to display the first instant message in the interface 300 in a manner of a first message display block 351.

If the user does not finish the input of the first instant message, the present invention judges whether the message transmission module 140 receives the second instant message sent by the first contactor (step 251). If yes, as shown in FIG. 4C, the message display module 150 displays the second instant message received by the message transmission module 140 around the second image 332 corresponding to the first contactor in a manner of a second message display block 352 (step 252), where the manner of displaying the instant message in the second message display block 352 by the message display module 150 is not limited to a popup window, and other manners, such as talk block and direct display, allowing the user know the content of the instant message sent by the first contactor can also be used by the present invention. In order to prevent shielding other useful parts in the interface 300 when displaying the second instant message, the message display module 150 pre-detects the displaying region occupied by the object in a certain scope around the second image 332 corresponding to the first contactor, and tries to put the display region which will be occupied by the second message display block 352 to the unoccupied display region, until the second message display block 352 will not shield other objects, thereby determining the position of the second message display block 352.

If the message transmission module 140 does not receive the second instant message either, the present invention continuously judges whether the user intends to send the first instant message (step 241).

When the user uses the interface 300 provided by the present invention, the user can randomly move the first image 331 corresponding to the user and the second image 332 corresponding to the first contactor in the interface 300, such that the first image 331 and the second image 332 move to any position in the interface 300 as desired. The moving manner is, for example, using a mouse etc., and any manners capable of moving the object in the frame can be used by the present invention.

In this manner, the interface of the present invention becomes lively and diverse, so as to solve the problem of the prior art that the interface is excessively dull.

In order to prevent the second instant message sent by the first contactor from being shielded by other window programs used by the user to lose the characteristic of “instant message”, the present invention can further use, for example, an application program interface (API) provided by the operation system to display the first image 331 and the second image 332, such that the first image 331 and the second image 332 are displayed in the interface 300 in a manner of being Always On Top, but the present invention is not limited to use the API provided by the operation system, and self-implementation can also be performed. In this manner, when the first contactor sends the second instant message to the user, the user can immediately find the newly received second instant message displayed around the second image 332.

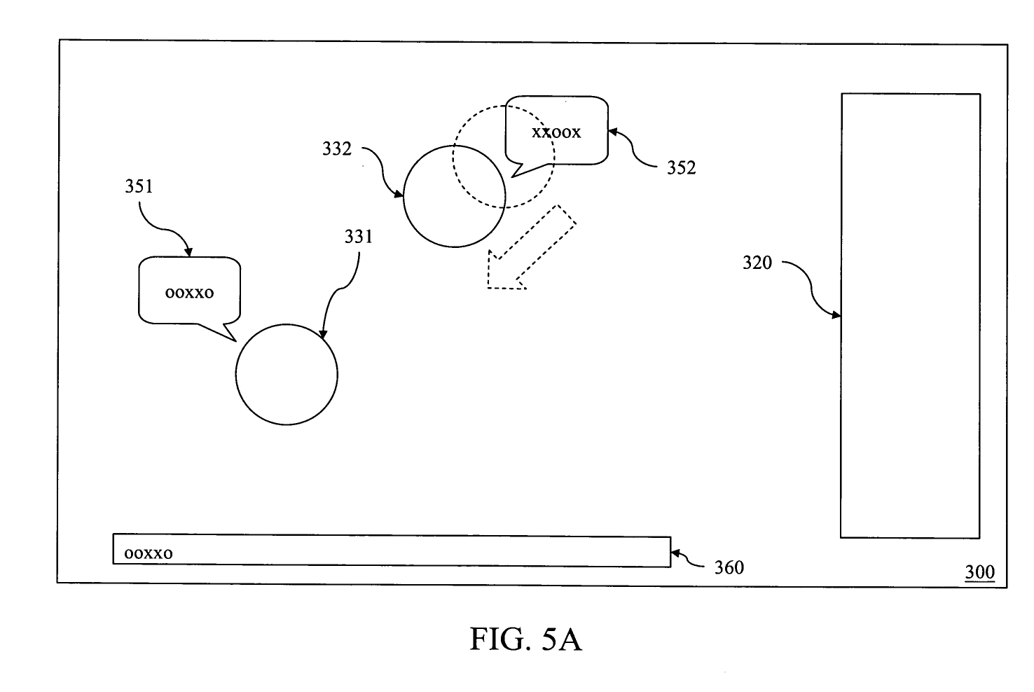

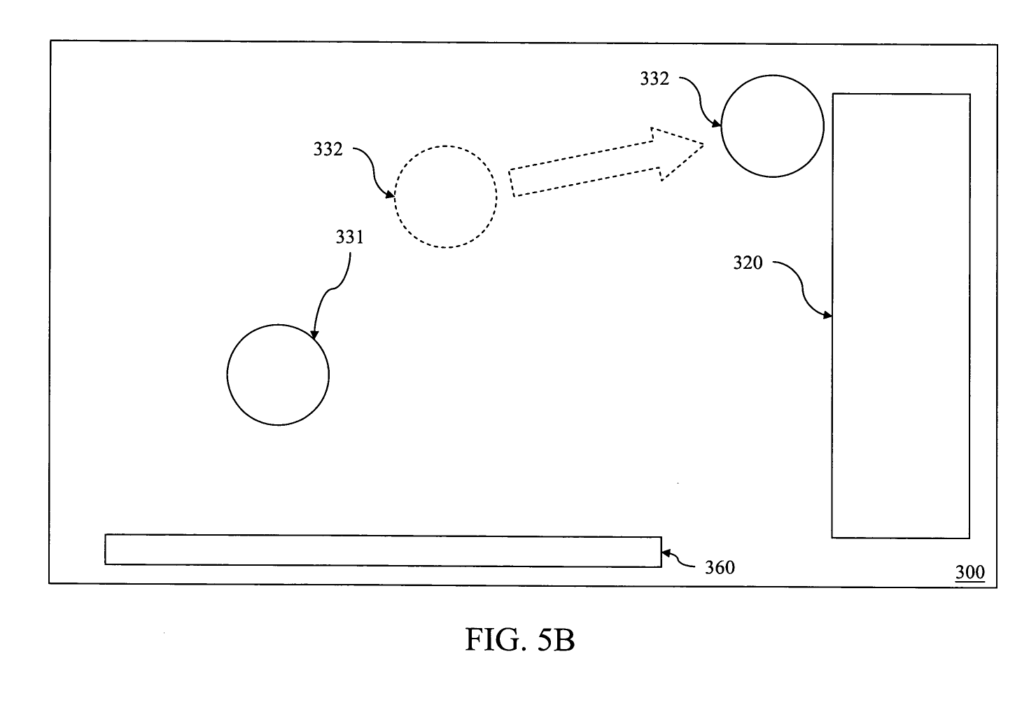

In order to make the interface 300 provided by the present invention be livelier, in the present invention, when the user and the first contactor have a conversation through the instant messaging service, the distance between the first image 331 corresponding to the user and the second image 332 corresponding to the first contactor is gradually shortened. For example, after the message transmission module 140 receives the second instant message sent by the first contactor, the image display module 130 moves the second image 332 corresponding to the first contactor towards a direction of the first image 331 for a certain distance, and re-displays the second image 332 corresponding to the first contactor (step 292), as shown in FIG. 5A. Similarly, when the user sends the first instant message to the first contactor, the image display module 130 also moves the first image 331 towards the direction of the first contactor (step 291).

In addition to moving the second image 332 corresponding to the first contactor towards the direction of the first image 331 corresponding to the user, the present invention also moves the second image 332 towards a direction away from the first image 331. When the second image 332 corresponding to the first contactor is displayed in the interface 300 for more than a certain time (e.g., 30 minutes), but the user does not have a conversation with the first contactor through the instant message service, the image display module 130 moves the second image 332 corresponding to the first contactor towards the direction away from the first image 331 (step 292), as shown in FIG. 5B.

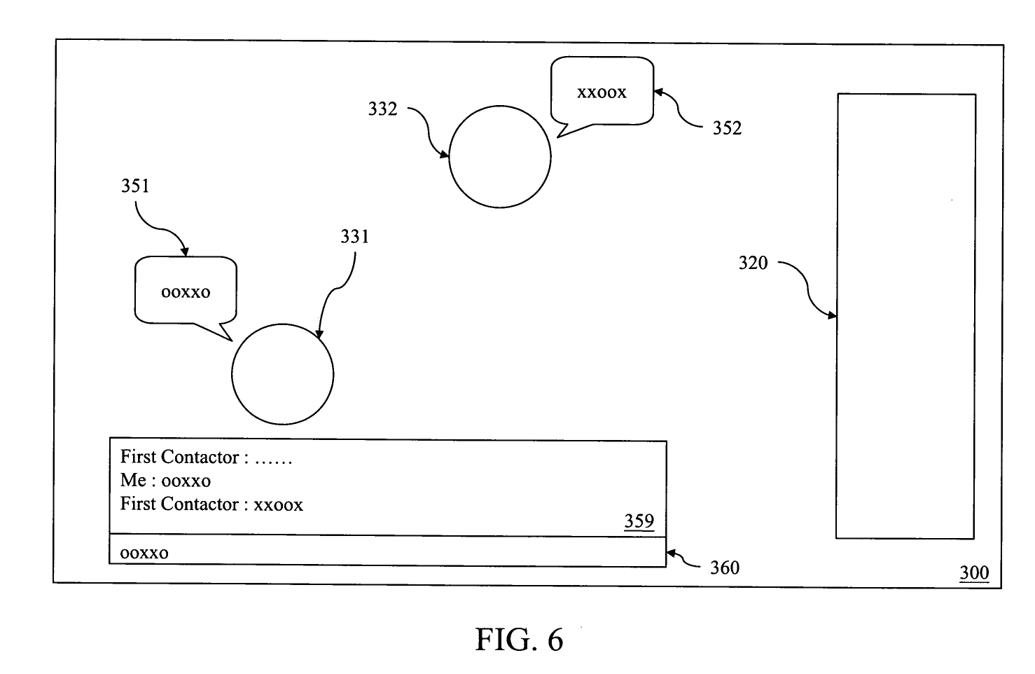

In addition, the interface 300 provided by the present invention further includes a history message list 359, as shown in FIG. 6. The message display module 150 displays the first instant message sent by the user to the first contactor and the second instant message sent by the first contactor to the user in the history message list 359, such that it is convenient for the user to search for the sent first instant message or the received second instant message. In order to be convenient for the user to achieve the objective, the message display module 150 uses a specific parameter as the reference of displaying the history message list 359. Generally, the specific parameter is the time of sending the first instant message or the time of receiving the second instant message.

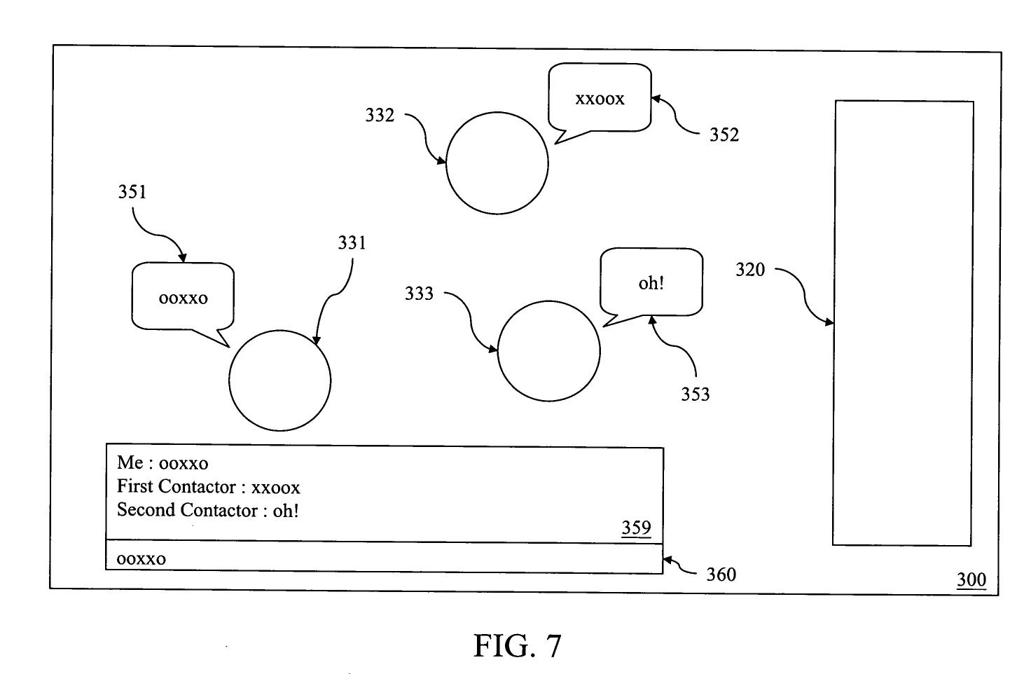

When selecting the contactor (step 220), the user simultaneously selects two contactors in the main menu 320, i.e., the first contactor and a second contactor, as shown in FIG. 7, the image display module 130 displays the second image 332 corresponding to the first contactor and a third image 333 corresponding to the second contactor in the interface 300 (step 230). In this manner, when the second instant message sent by the first contactor is “xxoox”, “xxoox” is displayed around the second image 332 corresponding to the first contactor by the message display module 150 in the manner of the second message display block 352 (step 251 and step 252). A second instant message “oh!” sent by the second contactor is displayed around the third image 333 corresponding to the second contactor by the message display module 150 in a manner of a third message display block 353 (step 251 and step 252), such that the user will not be confused by the second instant messages sent by the first contactor and the second contactor.

Further, the method of providing the instant message service provided by the present invention can be realized in hardware, software, or a combination of the hardware and the software, and can also be realized in a centralized computer system or in a dispersed manner by distributing different elements in several interconnected computer systems.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An interface of providing an instant messaging service, comprising:
a main window, for displaying a contactor list of a user;
a first image, corresponding to the user, for representing state of the user in the interface;
a message input block, provided for the user to input a first instant message;
a second image, respectively displayed in the interface after at least one contactor in the contactor list is selected, and respectively corresponding to each contactor, for representing state of each corresponding contactor; and
a message display block, displaying a second instant message sent by each contactor around each corresponding second image.

2. The interface of providing an instant messaging service as claimed in claim 1, wherein the main window further arranges display sequence of the contactors according to frequencies of talk between the user and the contactors.

3. The interface of providing an instant messaging service as claimed in claim 1, wherein the first image and the second image are displayed in the interface in a manner of being Always On Top.

4. The interface of providing an instant messaging service as claimed in claim 1, wherein the first image and the second image are further moved to random positions of the interface by operation of the user.

5. The interface of providing an instant messaging service as claimed in claim 1, wherein the second image is displayed in the interface in a manner of suddenly occurring in the interface.

6. The interface of providing an instant messaging service as claimed in claim 1, wherein the second image moves to enter the interface from a random position of a random side of each boundary of the interface.

7. The interface of providing an instant messaging service as claimed in claim 1, the message display block is displayed in the interface in a manner of a popup window.

8. The interface of providing an instant messaging service as claimed in claim 1, wherein the interface further comprises a history message list for displaying the first instant message sent by the user and the second instant message sent by each contactor.

9. A method of providing an instant message service, at least one contactor being set in a contactor list by a user, comprising the steps of:
displaying a first image representing state of the user, wherein the first image corresponds to the user;
selecting at least one contactor from the contactor list;
respectively displaying each of the second images representing state of each of the selected contactors, wherein each of the contactors and each of the second images are of a one-to-one relation;
after the user inputs a first instant message, sending the first instant message to at least one of the selected contactors; and
when a second instant message sent by one of each selected contactor is received, displaying the second instant message around the second image corresponding to the contactor.

10. The method of providing an instant messaging service as claimed in claim 9, wherein the step of displaying the second image further comprises:
determining a distance between the second image and the first image, according to a frequency of sending the instant messages between the contactor corresponding to the second image and the user; and
determining a position of the second image and displaying the second image, according to the distance and the position of the first image.

11. The method of providing a instant messaging service as claimed in claim 9, further comprising a step of moving the second image corresponding to the contactor towards an inverse direction of the first image, when it is judged that either at least one of the contactors or the user does not send the instant messages for a certain time.

12. The method of providing a instant messaging service as claimed in claim 9, further comprising a step of moving the second image corresponding to the contactor towards the first image, when it is judged that the user sends the first instant message to at least one of the contactors or at least one of the contactors receives the second instant message.

13. A system of providing an instant messaging service, comprising:
a contactor display module, for displaying all contactors of a user;
an image display module, for displaying a first image representing state of the user, and displaying each second image corresponding to each selected contactor when at least one of the contactors in the contactor display module is selected, wherein each of the second images respectively represents the state of each of the corresponding contactors;
a message input module, provided for inputting a first instant message;
a message transmission module, for sending the first instant message to at least one of the contactors and receiving a second instant message sent by at least one of the contactors; and
a message display module, for displaying the second instant message around the second image corresponding to the contactor.

14. The system of providing an instant messaging service as claimed in claim 13, wherein when receiving the second instant message, the image display module further moves the second image corresponding to the contactor, so as to shorten the distance between the second image and the first image.

15. The system of providing an instant messaging service as claimed in claim 13, wherein when either one of the contactors corresponding to the second image or the user does not send the first instant message and the second instant message in a certain time, the image display module further moves the second image away from the first image.

16. The system of providing an instant messaging service as claimed in claim 13, wherein the message display module is further used to display the first instant message sent by the user and the second instant message sent by each of the contactors according to a specific sequence.
